(19) United States
(12) Patent Application Publication
(10) Pub. No.: US 2026/0368955 A1
(43) Pub. Date: Nov. 19, 2026

(54) COLOR EFFECTS FOR DIGITAL ARTWORK

(71) Applicant: Adobe Inc., San Jose, CA (US)

(72) Inventors: Vinod Kumar Gambhir, Uttar Pradesh (IN); Manojkumar Santubhai Jain, Uttar Pradesh (IN)

(73) Assignee: Adobe Inc., San Jose, CA (US)

(21) Appl. No.: 19/209,347

(22) Filed: May 15, 2025

(51) Int. Cl. G06T 11/10; G06T 7/11; G06T 7/33; G06T 11/60

(52) U.S. Cl. CPC G06T 11/10; G06T 7/11; G06T 7/337; G06T 11/60; G06T 2200/24; G06T 2210/21

(57) ABSTRACT

In implementations of techniques and systems for applying color effects to digital artworks, a processing device implements a color effects module to receive a first artwork with one or more color effects to be applied to a second artwork. The color effects module determines an overlapping region of the first artwork overlapped by the second artwork. From the overlapping region, the color effects module then generates a transformed region of the first artwork to align with the corresponding region of the second artwork. The processing device generates a modified second artwork that includes the transformed region in the corresponding region of the second artwork.

### BACKGROUND

Graphic applications offer a range of features for creating and editing vector art, text-based art, and other digital content. However, applying multiple colors to different areas of the artwork can be challenging. Content creators often have to perform several manual editing steps to align and adjust the colors within their designs. The process becomes even more complicated if the user changes the chosen colors or rearranges elements in the artwork. Although content creation tools provide preset color effects or manual adjustment options, these techniques are ineffective, time-consuming, and difficult to manipulate various aspects of the colored artwork.

### SUMMARY

Techniques and systems for applying color effects to digital artwork are described. In one example, a processing device receives a source artwork to be applied or inserted as a color effect to a target artwork. The source artwork can include vector art, text-based art, or other digital images with one or more colors, icons, graphics, or other visual elements. The target artwork includes vector art, objects, text-based art, or other digital graphics.

Based on the relative positioning of the source artwork to the target artwork, the processing device determines regions of the source artwork that overlap with the target artwork. The processing device then transforms the overlapped regions to align with the corresponding regions of the target artwork. The transformation includes scaling, rotating, and repositioning the overlapped regions to fit precisely into the target artwork. In this way, the processing device generates a modified target artwork by placing the overlapped regions in the target artwork as a color effect.

This Summary introduces a simplified selection of concepts that are further described below in the Detailed Description. As such, this Summary is not intended to identify essential features of the claimed subject matter or to aid in determining its scope.

### BRIEF DESCRIPTION OF THE DRA WINGS

The patent or application file contains at least one drawing executed in color. The Office will provide copies of this patent or patent application publication with color drawing(s) upon request and payment of the necessary fee.

The detailed description is described with reference to the accompanying figures. Entities represented in the figures are indicative of one or more entities, and thus, reference is made interchangeably to single or plural forms of the entities in the discussion.

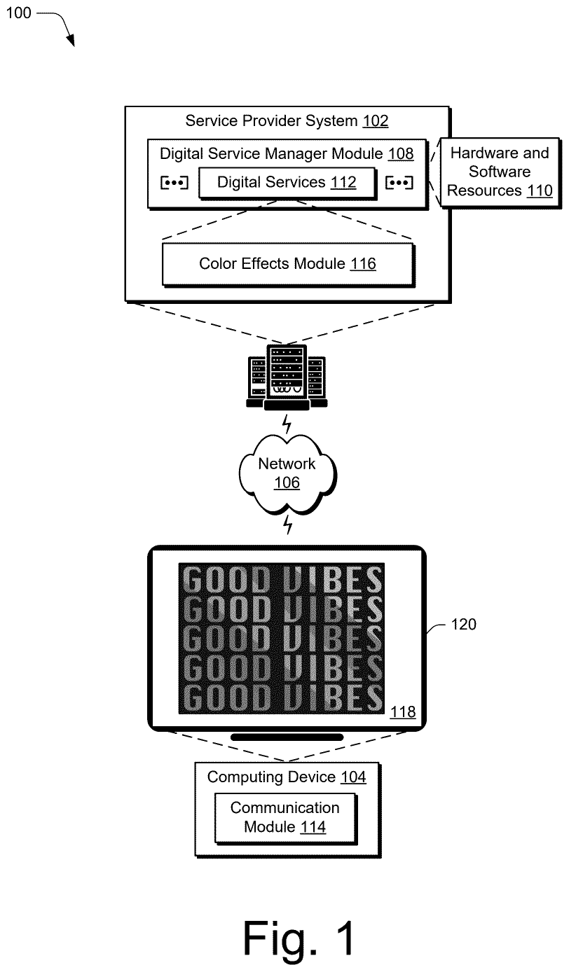

FIG. 1 illustrates a digital medium environment in an example implementation that is operable to employ color effects for digital artworks as described herein.

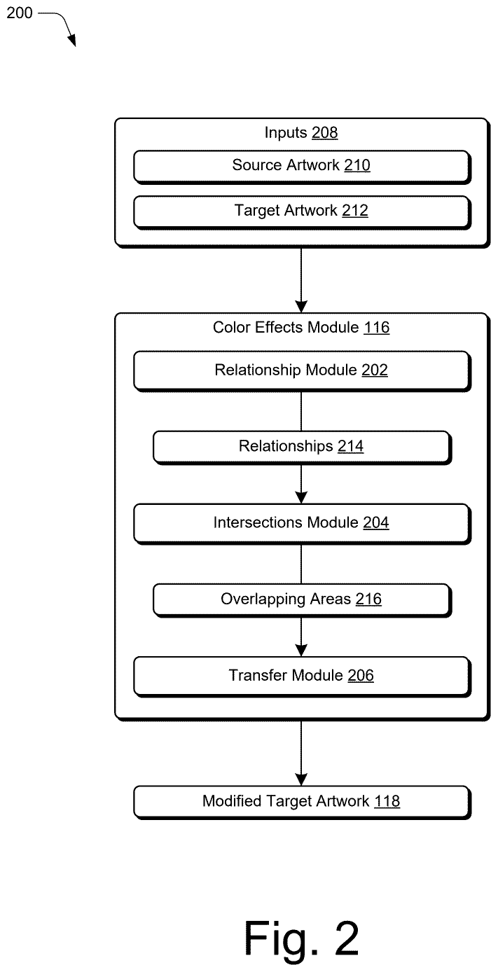

FIG. 2 depicts a system in an example implementation showing operation of a color effects module of FIG. 1 in greater detail as employing the techniques described herein.

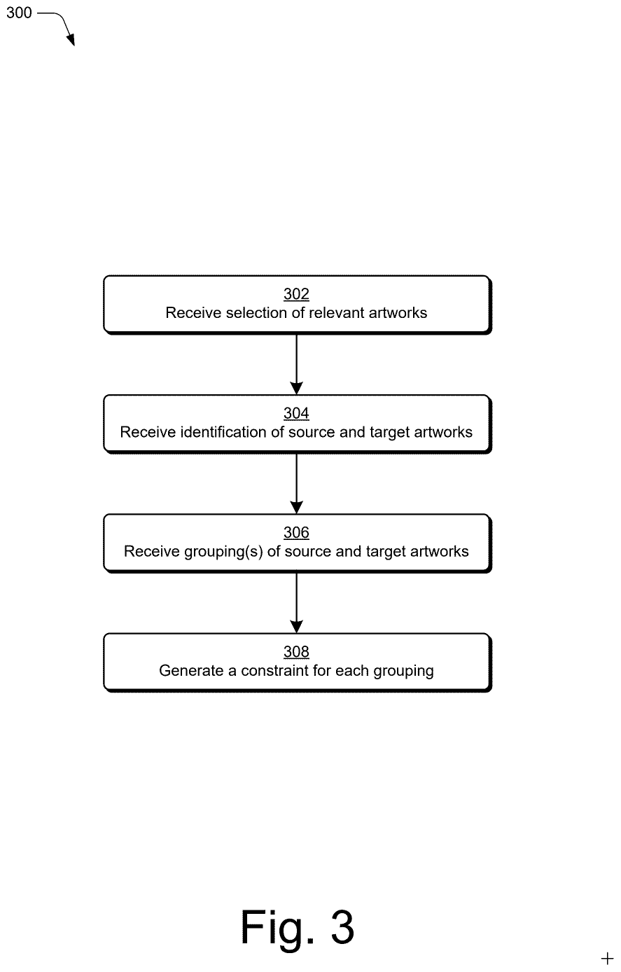

FIG. 3 depicts an example procedure of a relationship module for determining relationships between source artworks and target artworks in accordance with the techniques described herein.

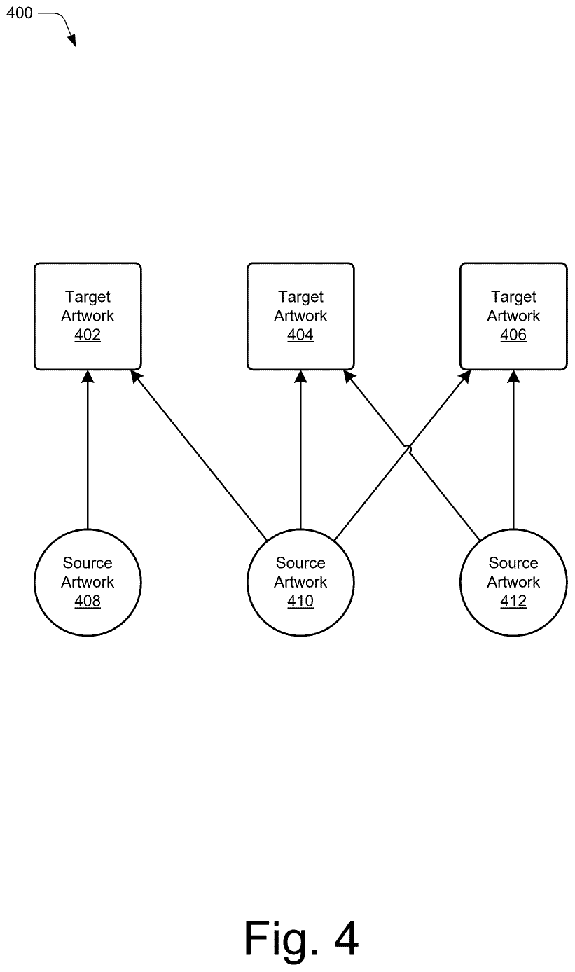

FIG. 4 illustrates an example of relationships between source artworks and target artworks in accordance with the techniques described herein.

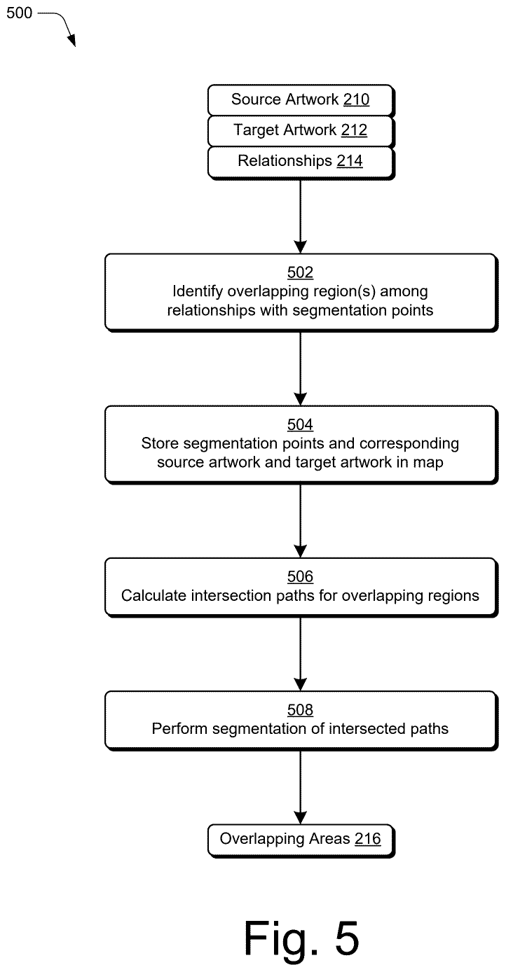

FIG. 5 depicts a procedure in an example implementation showing the operation of an intersections module that employs the techniques described herein to identify overlapping areas between target and source artworks.

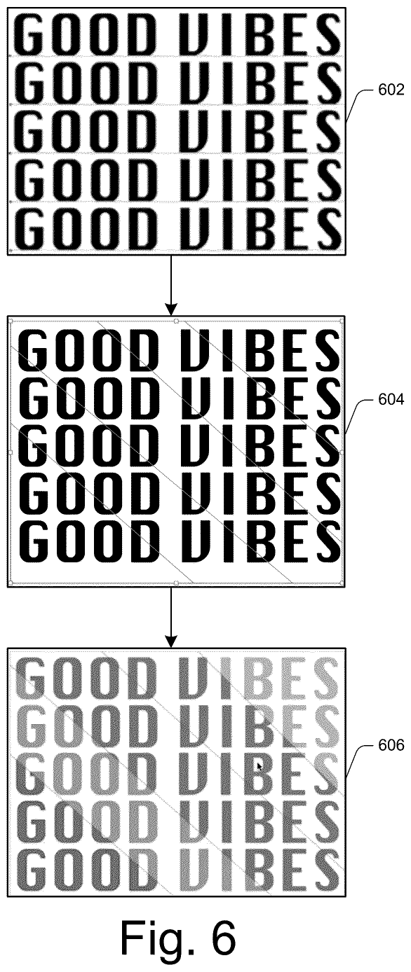

FIG. 6 illustrates an example of the operation of a color effects module to apply color effects to digital artwork employing the techniques described herein.

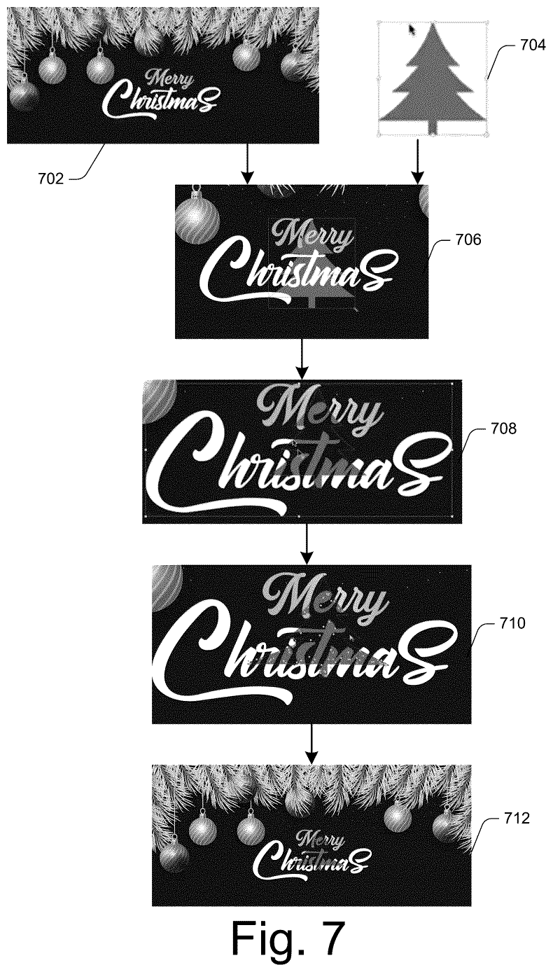

FIG. 7 illustrates another example of the operation of a color effects module to apply color effects to digital artwork employing the techniques described herein.

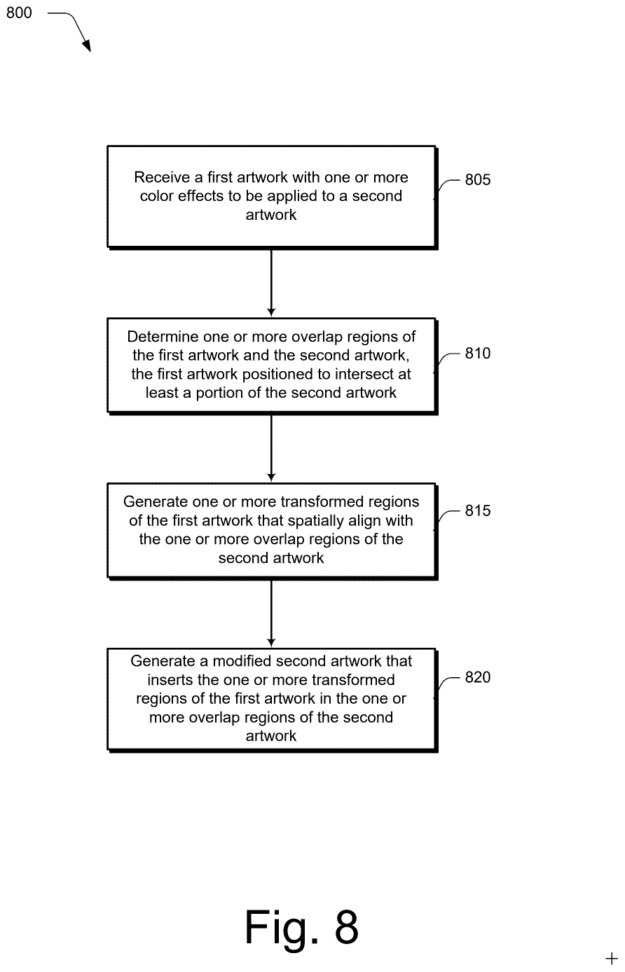

FIG. 8 is a flow diagram depicting a procedure in an example implementation in which a processing device applies color effects to digital artwork.

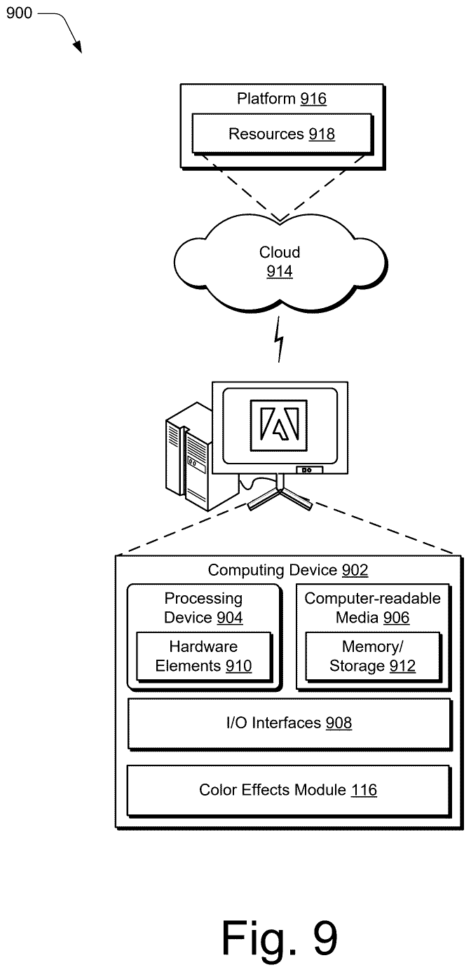

FIG. 9 illustrates an example system with an example computing device representative of one or more computing systems and/or devices usable to implement the techniques described herein.

### DETAILED DESCRIPTION

### Overview

Content creation services offer users convenient tools for creating and editing digital artwork. These services can accommodate a wide range of projects, from simple items like party invitations and family newsletters to more complex materials like business promotional materials and presentations. Various templates, text artwork, and vector artwork features are often provided to make the creation process easier and more efficient. Additionally, users can customize their artwork by changing colors, applying different effects, and resizing various objects, texts, and backgrounds.

It is common for users to personalize digital artwork by incorporating various color schemes throughout the content. However, applying multiple colors to different vector or text-based art areas can be challenging using traditional techniques. For example, designers often use clipping masks, knife tools, and pathfinders to create complex color combinations in vector art. These conventional tools, however, typically involve a manual and time-consuming process that often uses precise alignment to achieve the desired color schemes, causing user frustration and disappointment. These conventional tools also lack the flexibility and efficiency for making intricate color adjustments.

To overcome these and other limitations, techniques and systems for color management in digital artwork are described. For example, a computing device implements a color effects module to generate a relationship between source and target artworks. Each source artwork is a guide art with different fill colors or other visual elements for the target element. Each relationship can include one or more source artworks and one or more target artworks.

The areas of the target artwork that overlap with the source artwork are colored once the coloring effects are applied. Specifically, the color effects module uses a path intersection tool to identify the overlapping areas between source and target artworks. By calculating precise intersection paths between the source and target artworks, the color effects module ensures the final artwork is well-aligned and seamless. Once the segments are identified, each segment of the target artwork is transformed or replaced with the respective segment of the source artwork. The system ensures that the final artwork reflects the intended design and composition by transforming each source segment to align with the target artwork.

Consider a restaurant owner creating advertising material for a café to distribute at local businesses or to place on a website. The café specializes in freshly baked goods and a friendly atmosphere. The owner uses a template in a content creation service to list the available items and highlight the café's “good vibes.”

The restaurant owner wants to personalize the content by adding a rainbow effect to the words “good vibes” in a portion of the promotional material. However, after generating text artwork with “good vibes,” the owner realized that it was difficult and time-consuming to add a rainbow effect to the text artwork. The owner attempted to manually use a knife tool and masks to add multiple colors across the artwork but is dissatisfied with the results because the colors are misaligned across the different letters. Despite trying different available tools for over an hour, the owner is still unable to achieve the desired color effects. As a result, the owner decides to publish the material with solid coloring for the text artwork.

While conventional content creation services often fail to generate satisfactory results, the described techniques and systems for applying color effects to digital artwork provide an effective and convenient solution. For example, the described color effects module allows the restaurant owner to quickly modify the “good vibes” digital artwork to add the rainbow colors effect. The color effects module identifies the intersection or overlapping areas by identifying the rainbow artwork as the source artwork and the “good vibes” text-based art as the target artwork. A transformation is then performed on the different segments of the source artwork to align them with their corresponding regions of the target artwork. In this way, the color effects module applies the different colors across the target artwork with the colors extending across the word “good vibes” in a rainbow-like pattern.

The described color effect techniques help improve the quality of digital content with a simplified and precise process. By offering greater control, designers can efficiently manage complex layouts to enhance their creativity and finished products. The color effects module can be utilized for vector graphics and text-based artwork, offering broad utility across many potential designs. These approaches and other approaches described herein make it easy and efficient for users to create personalized digital artwork, providing a superior experience to conventional content creation services.

In the following discussion, an example environment is described that employs the techniques described herein. Example procedures are also described which are performable in the example environment and other environments. Consequently, performance of the example procedures is not limited to the example environment and the example environment is not limited to performance of the example procedures.

### Example Environment for Color Effects

FIG. 1 illustrates a digital medium environment 100 in an example implementation that is operable to employ color effects for digital artworks as described herein. The illustrated digital medium environment 100 includes a service provider system 102 and a computing device 104 that are communicatively coupled, one to another, via a network 106. Computing systems for the service provider system 102 and the computing device 104 are configurable in various ways. For instance, computing device 104 is associated with a user, and service provider system 102 is a remote computing system (e.g., one or more servers) configured to employ the described techniques and systems for generating color effects in digital artworks in graphics applications (e.g., vector graphics applications).

A computing system, for instance, is configurable as a desktop computer, laptop computer, mobile device (e.g., assuming a handheld configuration such as a tablet or mobile phone), server, and so forth. Thus, the service provider system 102 or the computing device 104 can range from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described with FIG. 9.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices, e.g., computing device 104. The digital services 112 include, for example, a graphics application to create, edit, and publish digital artworks.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, content generation service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a color effects module 116 for generating and manipulating color effects within digital artworks, including vector or text-based art. Although illustrated as implemented remotely by the service provider system 102, the functionality of the color effects module 116 is also configurable for local implementation, e.g., as part of the computing device 104.

The color effects module 116 provides a streamlined process to apply and edit multiple colors in digital artwork. The color application process is simplified to provide content creators with better control and reduced effort. To generate artwork with multiple colors, the color effects module 116 receives one or more source and target artworks. The source artwork includes a pattern or arrangement of multiple colors. The target artwork includes path, vector, text-based, and other digital artwork to which the multiple colors of the source artwork are to be applied. The color effects module 116 generates a modified target artwork 118 via a display 120 of the computing device 104, which colors the areas of the target artwork that overlap with the source artwork with the corresponding colors.

In general, functionality, features, and concepts described in the examples above and below are employed in the context of the example procedures described in this section. Further, functionality, features, and concepts described with different figures and examples in this document are interchangeable and are not limited to implementation in the context of a particular figure or procedure. Moreover, blocks associated with different representative procedures and corresponding figures herein are applicable together and/or combinable in different ways. Thus, individual functionality, features, and concepts described with different example environments, devices, components, figures, and procedures herein are usable in any suitable combinations and are not limited to the particular combinations represented by the enumerated examples in this description.

### Example Color Effects Systems and Techniques for Digital Artworks

FIG. 2 depicts a system 200 in an example implementation showing operation of a color effects module 116 of FIG. 1 as employing the techniques described herein. Generally, the color effects module 116 is operable to apply coloring or background effects from a source artwork to a target artwork to generate a modified target artwork 118. The color effects module 116 is illustrated as including a relationship module 202, an intersections module 204, and a transfer module 206.

The color effects module 116 receives as inputs 208 one or more source artworks 210 and one or more target artworks 212 and their positional coordinates. The source artworks 210 and the target artworks 212 can each be divided or segmented into individual elements. The source artworks 210 include vector art, text-based art, or other digital images with one or more colors, icons, graphics, or other visual elements to act as guides in applying coloring effects to the target artworks 212. The target artworks 212 include vector art, objects, text-based art, or other digital graphics to be visually modified by the source artworks 210.

After the color effects module 116 receives or collects the inputs 208, the relationship module 202 receives an indication of relationships 214 between the source artwork 210 and the target artwork 212. In particular, the relationship module 202 groups each target artwork 212 to one or more source artworks 210. Each relationship 214 can include one or more source artworks 210 and one or more target artworks 212.

The intersections module 204 identifies overlapping areas 216 between the source artwork 210 and the target artwork 212. In one implementation, the intersections module 204 uses path intersection API or intersection tool to detect regions or intersection points where the artworks intersect to accurately define the boundaries of the overlapping areas 216.

The transfer module 206 performs a transformation on each segment of the target artwork 212 to align them with respective segments of the source artwork 210. The transformation ensures that each segment of the target artwork 212 is positioned, oriented, and scaled correctly relative to the corresponding source segment to create a cohesive and accurate modified target artwork 118. The transfer module 206 determines points for the target artwork on the canvas as anchors to place the segments from the source artwork 210.

For each segment, the transfer module 206 identifies the segment's location (e.g., positional coordinates) in the source artwork 210 and determines how the segment is positioned or repositioned on the canvas according to the corresponding target artwork 212. The determination includes applying scaling, rotation, or other geometric adjustments to its coordinates to ensure the segment fits precisely into the designated area. For a coordinate point

$$p = ( \begin{matrix}x \\ y\end{matrix} )$$

and a transformation matrix

$$T = ( \begin{matrix}a & b \\ c & d\end{matrix} ) ,$$

the transformed coordinate point p′ is obtained by multiplying the matrix T by the vector p:

$${p}^{′} = Tp = ( \begin{matrix}a & b \\ c & d\end{matrix} ) ( \begin{matrix}x \\ y\end{matrix} ) = ( \begin{matrix}ax + by \\ cx + dy\end{matrix} )$$

The source segment with its coloring and fill is then placed or transferred to the target artwork 212 to generate the modified target artwork 118.

FIG. 3 depicts an example procedure 300 of a relationship module (e.g., the relationship module 202 of FIG. 2) for determining relationships between source artworks and target artworks in accordance with the techniques described herein.

At block 302, the relationship module 202 receives a selection of relevant artworks, including source artwork 210 and target artwork 212. The relevant artwork can be loaded, created, or generated within a graphics application of the digital services 112. In other implementations, the user imports or loads the relevant artwork from memory, a template database, or the internet or uses generative artificial intelligence (AI) to load the relevant artwork into the color effects module 116.

At block 304, the relationship module 202 receives an identification or designation of the selected artwork as either source artwork 210 or target artwork 212. The user can utilize various UI elements to designate each artwork as a source or target artwork. At block 306, the relationship module 202 also receives one or more groupings of source artwork 210 and target artwork 212. For example, the user can overlay one or more source artworks 210 over one or more target artworks 212 to indicate a grouping. In another implementation, the user identifies which target artworks 212 are grouped to a particular source artwork 210 as each source artwork 210 is identified. In one implementation, users can add, remove, or modify the relationships 214 at any time during the operation of the color effects module 116 to provide greater efficiency and ease.

At block 308, the relationships module 202 generates a constraint for each grouping or relationship to preserve the connection between the source artworks 210 and the target artworks 212. After the relationships 214 are generated, the user can modify the shape and coloring of the source artwork 210 and/or the target artworks 212. The defined constraints ensure that as the user makes updates to the source or target artworks these updates are carried forward to the modified target artwork 118. The constraint is triggered whenever any of the grouped artworks are marked as modified by the color effects module 116.

FIG. 4 illustrates an example 400 of relationships between source artworks and target artworks in accordance with the techniques described herein. As described above, the relationships module 202 receives an identification of the relationships 214 between source and target artworks. In the illustrated example 400, the inputs 208 includes target artworks 402, 404, and 406 and the source artworks 408, 410, and 412.

In example 400, the source artwork 408 is grouped to target artwork 402. The source artwork 410 is grouped to target artworks 402, 404, and 406. And the source artwork 412 is grouped to target artworks 404 and 406. As illustrated, each relationship includes one or more target artworks and one or more source artworks.

FIG. 5 depicts a procedure 500 in an example implementation showing the operation of an intersections module (e.g., the intersections module 204 of FIG. 2) that employs the techniques described herein to identify overlapping areas between target and source artworks. The intersections module 204 receives one or more source artworks 210, one or more target artworks 212, and relationships 214.

At block 502, the intersections module 204 identifies overlapping regions among the source artwork 210 and the target artwork 212 for each relationship 214. In one implementation, the intersections module 204 uses a path intersection api or pathfinder tool to accurately detect regions where the source artwork 210 and the target artwork 212 intersect and define the boundaries of the overlapping areas 216. In particular, the intersections module 204 calculates segmentation points along the intersecting paths representing points where the source artwork 210 and the target artwork 212 overlap in each relationship 214.

At block 504, the intersections module 204 stores or saves the segmentation points and the corresponding artwork for each relationship 214. In one implementation, the segmentation points are stored in a map along with the corresponding source artwork 210 and target artwork 212. The mapping assists with the transformation operations performed by the transfer module 206 to ensure that the transformations are precise and efficient.

At block 506, the intersections module 204 calculates the intersection paths for the overlapping regions. Precise intersection paths are determined to ensure that the segmented paths are accurate, which assists with transferring intricate artistic elements from a source artwork 210 to a target artwork 212.

At block 508, the intersections module 204 performs segmentation of the intersected paths to generate the overlapping areas 216. For example, the intersections module 204 segments the intersection paths on the target artwork 212.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Procedure for Applying Color Effects to Digital Artwork

The following discussion describes techniques that are implementable utilizing the previously described systems and devices. Aspects of the procedure are implementable in hardware, firmware, software, or a combination thereof. The procedure is illustrated as a set of blocks that specify operations performed by one or more devices and are not necessarily limited to the orders shown for performing the operations by the respective blocks. In portions of the following discussion, reference is made to FIGS. 1 through 5.

FIG. 6 illustrates an example of the operation of a color effects module to apply color effects to digital artwork employing the techniques described herein.

In the illustrated example, a user identifies the repeated text “GOOD VIBES” as a target artwork 602. Using a graphics application, the user then generates a source artwork 604 that includes a square (e.g., the red square) around the target artwork 602. The square is divided into five source elements by a series of diagonal lines (represented by the red diagonal lines). The user applies a different color to each source element.

The color effects module 116 applies the coloring of the source artwork 604 to the target artwork 602 to generate the modified target artwork 606 with the text art colored to have a rainbow effect. In this way, the described techniques offer a step-by-step approach that allows users to apply multiple colors and coloring effects to digital artwork efficiently and precisely.

FIG. 7 illustrates an example of the operation of a color effects module to apply color effects to digital artwork employing the techniques described herein.

In the illustrated example, a target artwork 702 includes a holiday card that includes Christmas ornaments hanging from a fir tree and the words “Merry Christmas” in cursive script. A source artwork 704 includes a green fir tree that the designer wishes to superimpose onto the words in the holiday card. The designer first identifies the words “Merry Christmas” as target elements and the fir tree as the source element. In image 706, the designer identifies a positional relationship between the source and target elements by overlaying the source artwork 704 on the target artwork 702.

After the relationships 214 are defined, the color effects module 116 determines the overlapping areas 216 between the source element and the target elements in image 708. For example, the overlapping segments between the letters in “Merry Christmas” and the fir tree are determined. The color effects module 116 then fills in the overlapping areas 216 of the target elements with the green coloring of the source element. As illustrated in image 710, the segmentation points that define the overlapping areas 216 are displayed as user-interface (UI) elements that the designer can move for the target elements to adjust the color effects. In the illustrated example, the designer widens the base of the fir tree to fill in additional portions of the letters in “Christmas.” The modified target artwork 118 is displayed in image 712 with the green fir tree of the source artwork 704 filling in portions of the “Merry Christmas” text in the target artwork 702.

In this way, the designer can quickly and easily apply the source artwork 704 to the target artwork 702 without the complexity of conventional techniques. Using a conventional technique, the designer uses a knife tool to create segments for each affected letter in the “Merry Christmas” text. If the designer wants to adjust the fir tree's shape, each segment is adjusted in a tedious and time-consuming process. In contrast, the described techniques provide greater control and precision to allow designers to manage complex layouts, enhancing creativity and workflow efficiency.

FIG. 8 is a flow diagram depicting an algorithm as a step-by-step procedure 800 in an example implementation that is performable by a processing device to apply color effects to digital artwork. In other implementations, one or more steps of the procedure 800 are performed on additional digital artwork.

To begin, a processing device (e.g., digital services 112) receives a first artwork with one or more colors to be applied to a second artwork (block 805). For example, the first artwork is the source artwork 210 and the second artwork is the target artwork 212. The first and second artwork include at least one of vector art, text-based art, or other digital artwork with one or more colors, icons, graphics, or other visual elements. The relationship module 202 identifies the first artwork as a source artwork 210 with one or more visual elements to be applied to the second artwork, which is identified as a target artwork 212. The relationship module 202 also identifies a positional relationship (e.g., relationship 214) between the first artwork and the second artwork with one or more overlapping regions.

The relationship module 202 also generates a constraint that groups the first artwork with the second artwork. In response to (subsequently) receiving a modification to the first artwork, the second artwork, or the positional relationship between them, the color effects module 116 automatically updates the modified second artwork (e.g., the modified target artwork 118) to include the modification. In one implementation, the constraint includes one or more first/source artworks grouped with one or more second/target artworks. The modified target artwork 118 is automatically updated in response to a modification to any artwork in the constraint.

The processing device (e.g., intersections module 204) determines one or more overlapping regions (e.g., overlapping areas 216) of the first artwork and the second artwork (block 810). The first artwork is positioned to intersect at least a portion of the second artwork. For example, the intersections module 204 uses a path intersection tool to identify multiple segmentation points that define intersection paths between the first artwork and the second artwork for the overlapping regions. The segmentation points are stored along with corresponding overlapping regions of the first artwork and the second artwork in a map or database. The intersections module 204 uses the segmentation points to determine, outline, or select segments of the first artwork and the second artwork that correspond to the one or more overlapping regions.

The processing device then generates one or more transformed regions of the first artwork that spatially align with the one or more overlap regions of the second artwork (block 815). For example, the transfer module 206 determines one or more reference points within the second artwork to serve as anchors where the first artwork's segments are placed in the second artwork. The transfer module 206 also determines the positioning of each segment in the first artwork in the second artwork, which can include scaling or rotating the segment to fit in the corresponding segment of the second artwork.

The processing device generates a modified second artwork that inserts the one or more transformed regions of the first artwork in the one or more overlap regions of the second artwork (block 820). In this way, the color effects module 116 provides an efficient and simple technique for users to apply coloring effects from a source artwork to a target artwork.

### Example System and Device

FIG. 9 illustrates an example system 900 that includes an example computing device 902 that is representative of one or more computing systems and/or devices that implement the various techniques described herein. This is illustrated through inclusion of the color effects module 116. The computing device 902 is configurable, for example, as a server of a service provider, a device associated with a client (e.g., a client device), an on-chip system, and/or any other suitable computing device or computing system.

The example computing device 902, as illustrated, includes a processing device 904, one or more computer-readable media 906, and one or more I/O interface 908 that are communicatively coupled to one another. Although not shown, the computing device 902 further includes a system bus or other data and command transfer system that couples the various components from one to another. A system bus can include any one or combination of different bus structures, such as a memory bus or memory controller, a peripheral bus, a universal serial bus, and/or a processor or local bus that utilizes various bus architectures. A variety of other examples are also contemplated, such as control and data lines.

The processing device 904 is representative of the functionality to perform one or more operations using hardware. Accordingly, the processing device 904 is illustrated as including hardware element 910 that is configurable as processors, functional blocks, and so forth. This includes implementation in hardware as an application-specific integrated circuit (ASIC) or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways, as further described below, to support user interaction.

Various techniques are described in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 902, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic, and/or fixed device logic implemented in a hardware form that are employed in some implementations to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through a distributed system, such as over a “cloud” 914 via a platform 916 as described below.

The cloud 914 includes and/or is representative of a platform 916 for resources 918. The platform 916 abstracts the underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also abstracts the scaling of resources to provide a corresponding level of scale to the encountered demand for the resources 918 implemented via the platform 916. Accordingly, in an interconnected device implementation, the implementation of functionality described herein is distributable throughout the system 900. For example, the functionality is implementable in part on the computing device 902 as well as via the platform 916 that abstracts the functionality of the cloud 914.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
determining, by a processing device, an overlap region of a first artwork and a second artwork, the first artwork including one or more color effects and positioned to intersect at least a portion of the second artwork;
generating, by the processing device, a transformed region of the first artwork that spatially aligns with the overlap region of the second artwork; and
generating, by the processing device, a modified second artwork that inserts the transformed region of the first artwork in the overlap region of the second artwork, the modified second artwork including the one or more color effects.

2. The method of claim 1 further comprising:
identifying, by the processing device, a positional relationship of the first artwork to the second artwork.

3. The method of claim 2 further comprising:
generating a constraint that groups the first artwork with the second artwork; and
in response to receiving a modification to the first artwork, the second artwork, or the positional relationship, updating the modified second artwork.

4. The method of claim 3, wherein:
the constraint includes one or more first artworks grouped with one or more second artworks; and
the modified second artwork is automatically updated in response to receiving a modification to any of the one or more first artworks or the one or more second artworks.

5. The method of claim 1, wherein determining the overlap region comprises identifying, using a path intersection tool, multiple segmentation points that define intersection paths between the first artwork and the second artwork.

6. The method of claim 5, wherein the multiple segmentation points are stored along with corresponding overlap regions of the first artwork and the second artwork.

7. The method of claim 5 further comprising:
generating, using the multiple segmentation points, segments of the first artwork and the second artwork that correspond to the overlap region.

8. The method of claim 7 further comprising:
determining one or more reference points within the second artwork to serve as anchors where the segments of the first artwork are to be placed in the second artwork; and
determining a positioning of each segment in the second artwork.

9. The method of claim 8, wherein the positioning of each segment includes scaling or rotating of a segment to fit in a corresponding segment of the second artwork.

10. The method of claim 1, wherein the first artwork includes at least one of vector art, text-based art, or other digital artwork with one or more icons, graphics, or other visual elements to be applied to the second artwork.

11. A system comprising:
a memory component; and
one or more processing devices coupled to the memory component, the one or more processing devices to perform operations comprising:
receive a first artwork with one or more visual elements that include one or more color effects, icons, graphics, or other visual elements to be applied to a second artwork;
receive positional information of the first artwork relative to the second artwork, the first artwork being positioned to intersect at least a portion of the second artwork;
determine, based on the positional information, an overlap region of the first artwork and the second artwork;
generate a transformed region of the overlap region of the first artwork that spatially aligns with the overlap region of the second artwork; and
generate a modified second artwork that includes the transformed region in the overlap region of the second artwork with the one or more visual elements.

12. The system of claim 11, wherein the one or more processing devices to perform further operations comprising:
generate a constraint that groups the first artwork with the second artwork; and
in response to receiving a modification to the first artwork, the second artwork, or the positional information, update the modified second artwork.

13. The system of claim 11, wherein the one or more processing devices determine the overlap region by identifying, using a path intersection tool, segmentation points that define intersection paths between the first artwork and the second artwork.

14. The system of claim 13, wherein the one or more processing devices to perform further operations comprising:
generate, using the segmentation points, segments of the first artwork and the second artwork that correspond to the overlap region.

15. The system of claim 14, wherein the one or more processing devices to perform further operations comprising:
determine one or more reference points within the second artwork to serve as anchors where the segments of the first artwork are to be placed in the second artwork; and
determine a positioning of each segment in the second artwork.

16. The system of claim 15, wherein the positioning of each segment includes scaling or rotating of a segment to fit in a corresponding segment of the second artwork.

17. A non-transitory computer-readable medium storing executable instructions, which when executed by a processing device, cause the processing device to perform operations comprising:
receive a first artwork with one or more visual elements to be applied to a second artwork;
determine an overlap region of the first artwork and the second artwork, the first artwork being positioned to intersect at least a portion of the second artwork;
generate a transformed region of the first artwork that spatially aligns with the overlap region of the second artwork; and
generate a modified second artwork that inserts the transformed region in the overlap region of the second artwork with the one or more visual elements.

18. The non-transitory computer-readable medium of claim 17, wherein the executable instructions, which when executed by the processing device, further cause the processing device to perform operations comprising:
identify, using positional coordinates of the first artwork and the second artwork, a positional relationship of the first artwork to the second artwork; and
automatically update the modified second artwork in response to receiving a modification to the first artwork, the second artwork, or the positional relationship.

19. The non-transitory computer-readable medium of claim 17, wherein the executable instructions, which when executed by the processing device, further cause the processing device to perform operations comprising:
determine the overlap region by identifying, using a path intersection tool, multiple segmentation points that define intersection paths between the first artwork and the second artwork; and
generate, using the multiple segmentation points, segments of the first artwork and the second artwork that correspond to the overlap region.

20. The non-transitory computer-readable medium of claim 17, wherein the first artwork includes at least one of vector art, text-based art, or other digital artwork with one or more color effects, icons, graphics, or other visual elements to be applied to the second artwork.
